(19) United States
(12) Patent Application Publication
(10) Pub. No.: US 2008/0122894 A1
(43) Pub. Date: May 29, 2008

(54) HEAD CHIP AND INK CARTRIDGE AND IMAGE FORMING APPARATUS HAVING THE SAME

(75) Inventors: Jin-wook Lee, Seoul (KR); Dong-sik Shim, Suwon-si (KR); Sung-joon Park, Suwon-si (KR); Bang-weon Lee, Yongin-si (KR); Sang-hyun Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/767,718

(22) Filed: Jun. 25, 2007

(30) Foreign Application Priority Data
Nov. 23, 2006 (KR) 2006-116463

(51) Int. Cl. B41J 2/145; B41J 2/175

(52) U.S. Cl. 347/47; 347/87

(57) ABSTRACT

A head chip usable in an image forming apparatus, the head chip includes a nozzle layer having a nozzle to discharge ink onto a recording medium, a substrate layer having an ink supplying slit provided to be parallel with the nozzle layer to supply the nozzle with the ink, and a reinforcing bridge provided along an extending direction of the ink supplying slit and blocks at least one region of the ink supplying slit.

### CROSS-REFERENCE TO RELATED APPLICATIONS

This application claims priority under 35 U.S.C. §119(a) from Korean Patent Application No. 2006-0116463, filed on Nov. 23, 2006 in the Korean Intellectual Property Office, the disclosure of which is incorporated herein in its entirety by reference.

### BACKGROUND OF THE INVENTION

1. Field of the Invention

The present general inventive concept relates to a head chip and ink cartridge and an image forming apparatus having the same, and more particularly, to a head chip and ink cartridge having an improved ink supplying slit structure and an image forming apparatus having the same.

2. Description of the Related Art

An image forming apparatus forms image data onto a recording medium according to a printing signal which is applied by a host. Generally, the image forming apparatus is divided into an inkjet type where an image is formed by discharging ink onto a recording medium, an electrophotographic type where the image is formed by selectively applying developer onto the recording medium using electric potential differences among a photosensitive member, the developer, and a transfer roller, and a thermal printing type where the image is formed by contacting an ink ribbon coated with ink with the recording medium and applying heat and pressure to transfer the ink to the recording medium.

According to the inkjet type image forming apparatus, an ink cartridge in which the ink is stored discharges the ink onto the recording medium to form the image. The inkjet type image forming apparatus is divided into a shuttle type, where the ink cartridge discharges the ink while it shuttles in a direction perpendicular to a feeding direction of the recording medium, and a line head type, where the ink cartridge is provided to have a width to correspond to a width of the recording medium and forms the image by discharging the ink per whole width.

FIG. 1 is a perspective view illustrating a conventional ink cartridge 10. As illustrated in FIG. 1, the ink cartridge 10 comprises an ink storing part 11 which stores the ink, and a flexible printed circuit board (FPCB) 20, which is attached to the ink storing part 11 and exchanges an electrical signal with an image forming apparatus main body (not illustrated) through a contact pad 21. The FPCB 20 comprises a head chip 30 which discharges the ink of the ink storing part 11 onto the recording medium. The head chip 30 is attached to a head chip receiving hollow 13 of the ink cartridge 10. The head chip 30 is coupled with the head chip receiving hollow 13 by an adhesive.

FIGS. 2A and 2B are sectional views illustrating the ink cartridge 10 of FIG. 1. Referring to FIGS. 2A and 2B, the head chip 30 comprises a substrate layer 32 having an ink supplying slit 31 which is supplied with the ink from an ink supplying hole 15 of the ink storing part 11, a chamber layer 34 having a heater 33 which heats the ink supplied from the ink supplying slit 31, and a nozzle layer 36 having a nozzle 35 where an ink bubble generated by heat from the heater 33 is used to discharge the ink to an outside.

To manufacture the conventional ink cartridge having above structure, an adhesive A is applied onto a border surface to couple the head chip 30 with the ink storing part 11, and then the ink cartridge goes through a heat treatment at about 110° C. Therefore, the head chip 30 and the ink storing part 11 are solidly coupled therebetween.

However, since the ink storing part 11 of the conventional ink cartridge 10 is made of plastics and the substrate layer 32 of the head chip 30 is made of silicon, a shear stress F is generated on the border surface between the two materials which are of different kinds by a difference in coefficients of thermal expansion while the ink cartridge 10 goes through the heat treatment at about 110° C. In particular, as the coefficient of thermal expansion of the plastics is 50 times greater than that of the silicon, a bending deformation δ is generated in the substrate layer 32 as illustrated in FIG. 2B. The bending deformation of the substrate layer 32 causes a bending deformation of the nozzle layer 36, which is provided at an upper side of the substrate 32.

If the deformation is generated in the nozzle layer 36, the ink is discharged through the nozzle 35 obliquely instead of perpendicularly onto the recording medium, so that a printing quality is deteriorated.

Also, during a wiping process for removing foreign substances or ink which is attached to a surface of the nozzle, the nozzle layer 36 may be damaged due to the bending deformation of the nozzle layer 36.

Moreover, the problem caused by the bending deformation of the head chip 36 as described above may be more serious in a case of a line head, where the head chip 30 is plurally provided.

### SUMMARY OF THE INVENTION

The present general inventive concept provides a head chip and ink cartridge having a reinforcing bridge to minimize deformation of the head chip when the head chip is coupled with an ink storing part, and an image forming apparatus having the same.

Additional aspects and utilities of the present general inventive concept will be set forth in part in the description which follows and, in part, will be obvious from the description, or may be learned by practice of the present general inventive concept.

The foregoing and/or other aspects and utilities of the present general inventive concept can be achieved by providing a head chip usable in an image forming apparatus, the head chip comprising a nozzle layer having a nozzle to discharge ink onto a recording medium, a substrate layer having at least one ink supplying slit provided to be parallel with the nozzle layer to supply the nozzle with the ink, and at least one reinforcing bridge provided along an extending direction of the ink supplying slit and blocks at least one region of the ink supplying slit.

A thickness of the reinforcing bridge may not greater than the thickness of the substrate layer.

A width d of the reinforcing bridge may be p×2≦d≦p×6 and p may be a pitch between adjacent nozzles.

The reinforcing bridge may be provided plurally along the extending direction of the ink supplying slit.

The substrate layer may comprise a plurality of ink supplying slits which are provided to be parallel therewith.

Each of the plurality of ink supplying slits may supply the nozzle with ink of a different color.

A reinforcing bridge of a first ink supplying slit may be aligned with a reinforcing bridge of a neighboring ink supplying slit.

A reinforcing bridge of a first ink supplying slit may not align with a reinforcing bridge of an adjacent ink supplying slit.

The foregoing and/or other aspects and utilities of the present invention can also be achieved by providing an ink cartridge usable in an image forming apparatus, the ink cartridge comprising an ink storing part, and a head chip disposed at a lower side of the ink storing part to discharge ink onto a recording medium, the head chip comprising a nozzle layer having a nozzle to discharge ink onto a recording medium, a substrate layer having at least one ink supplying slit provided to be parallel with the nozzle layer and supplies the nozzle with the ink, and at least one reinforcing bridge provided along an extending direction of the ink supplying slit and blocks at least one region of the ink supplying slit.

The ink storing part may be provided to correspond to a width of a printing medium and may comprise a plurality of head chips.

The foregoing and/or other aspects and utilities of the present invention can also be achieved by providing an ink cartridge usable in an image forming apparatus, the ink cartridge comprising an ink storing part, and a head chip coupled to the ink storing part, the head chip comprising a substrate, a plurality of ink supplying slits formed in the substrate, a chamber layer formed on the substrate and defining a plurality of ink chambers, a nozzle layer defining a plurality of nozzles to eject ink, an ink discharging device disposed in the ink chamber to provide an energy to eject ink from the ink chamber through the nozzles, and a plurality of reinforcing bridges disposed within the ink supplying slits to strengthen the head chip and prevent a deformation thereof when the head chip is coupled to the ink storing part.

Each of the plurality of reinforcing bridges may have a thickness equal or less than a thickness of the substrate.

The plurality of reinforcing bridges may be disposed in an alternating pattern with respect to adjacent ink supplying slits.

The plurality of reinforcing bridges may be disposed in an aligning pattern with respect to adjacent ink supplying slits.

A width of each reinforcing bridge may be p×2≦d≦p×6 and p may be a pitch between adjacent nozzles.

The ink cartridge may be a line printing type head cartridge and the head chip may comprise a plurality of head chips disposed along a length of the ink cartridge corresponding to a width of a printing medium.

The ink discharging device may be one of a piezoelectric device to apply a deformation pressure to the ink and a heater to heat the ink and generate bubbles in the ink to eject ink through the nozzles.

The foregoing and/or other aspects and utilities of the present invention can also be achieved by providing a reinforced head chip usable in an image forming apparatus, the head chip comprising a substrate having ink supplying slits formed thereon, a chamber layer formed on the substrate to define an ink chamber, a nozzle layer formed above the chamber layer to define a nozzle, an ink discharging device disposed in the ink chamber to provide an energy to eject ink from the ink chamber through the nozzles, and at least one reinforcing bridge provided in at least one ink supplying slit to strengthen the head chip and prevent a deformation thereof when the head chip is coupled to an ink storing part of an ink cartridge.

A height of the at least one reinforcing bridge may be equal or less than a height of the substrate where the reinforcing bridge is disposed.

A width of each reinforcing bridge may be p×2≦d≦p×6 and p may be a pitch between adjacent nozzles.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is an exploded perspective view illustrating a conventional ink cartridge;

FIG. 2A and FIG. 2B are sectional views illustrating the conventional ink cartridge of FIG. 1 before deformation and after deformation, respectively;

FIG. 3A and FIG. 3B illustrate a plan view and a sectional view, respectively, of a substrate layer of a head chip according to an exemplary embodiment of the present general inventive concept;

FIG. 4A and FIG. 4B are sectional views illustrating the head chip according to the exemplary embodiment of the present general inventive concept;

FIG. 5 is an expanded plan view illustrating a reinforcing bridge of the head chip according to an exemplary embodiment of the present general inventive concept;

FIG. 6A and FIG. 6B illustrate experimental results about a strength of the head chip according to an exemplary embodiment of the present general inventive concept; and

FIG. 7 is a plan view illustrating an ink cartridge according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

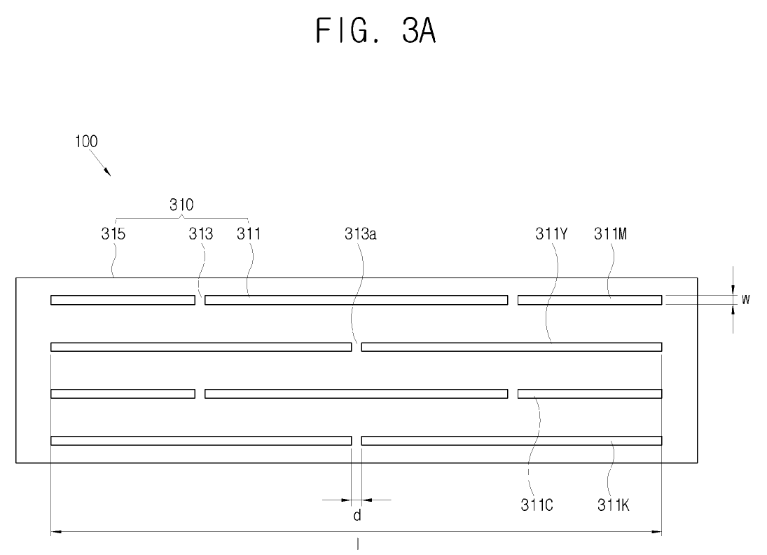

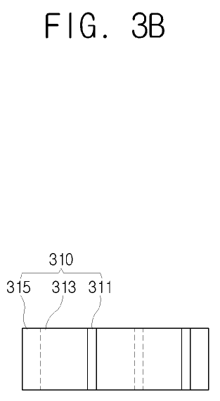

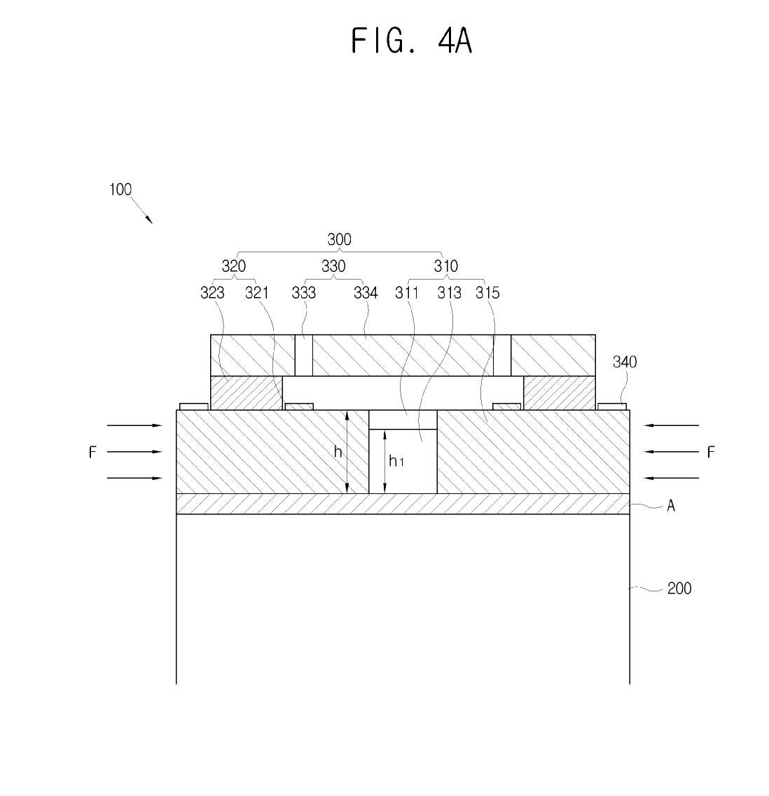

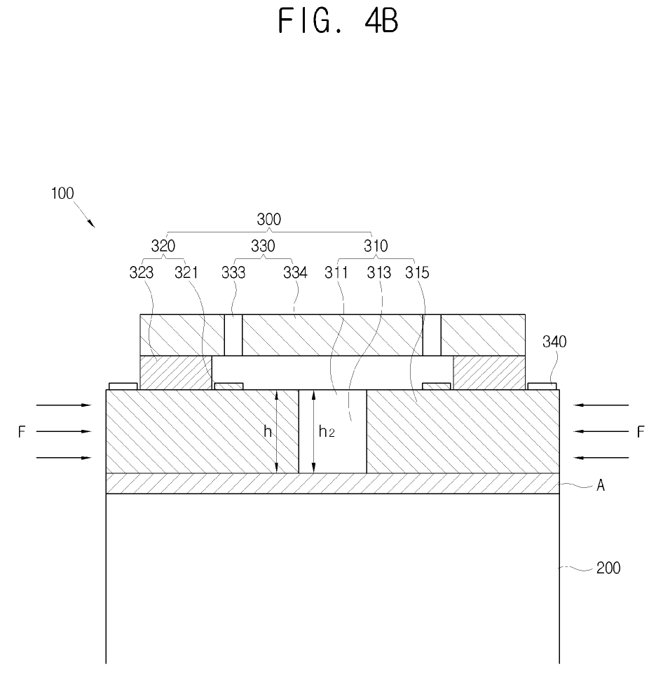

FIG. 3A and FIG. 3B are a plan view and a sectional view, respectively, illustrating a substrate layer of a head chip according to an exemplary embodiment of the present general inventive concept. FIG. 4A is a sectional view illustrating the head chip of FIGS. 3A and 3B.

As illustrated in FIG. 3A, FIG. 3B, and FIG. 4A, an ink cartridge 100 according to the exemplary embodiment of the present general inventive concept may comprise an ink storing part 200 to store ink, and a head chip 300 which is provided at a lower side of the ink storing part 200 to discharge the ink from the ink storing part 200 onto a recording medium.

The ink storing part 200 may comprise an ink chamber (not illustrated) in which the ink is stored, a foam chamber (not illustrated) to discharge the ink into the head chip 300 by a predetermined negative pressure, and a partitioning wall (not illustrated) to separate the ink chamber (not illustrated) from the foam chamber (not illustrated). A connecting opening part (not illustrated) may be provided at a lower end part of the partitioning wall (not illustrated) to allow the ink to flow from the ink chamber (not illustrated) to the foam chamber (not illustrated).

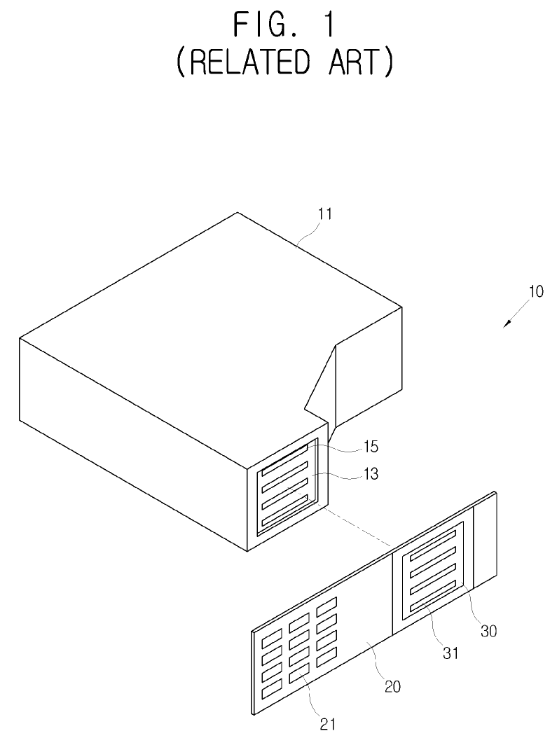

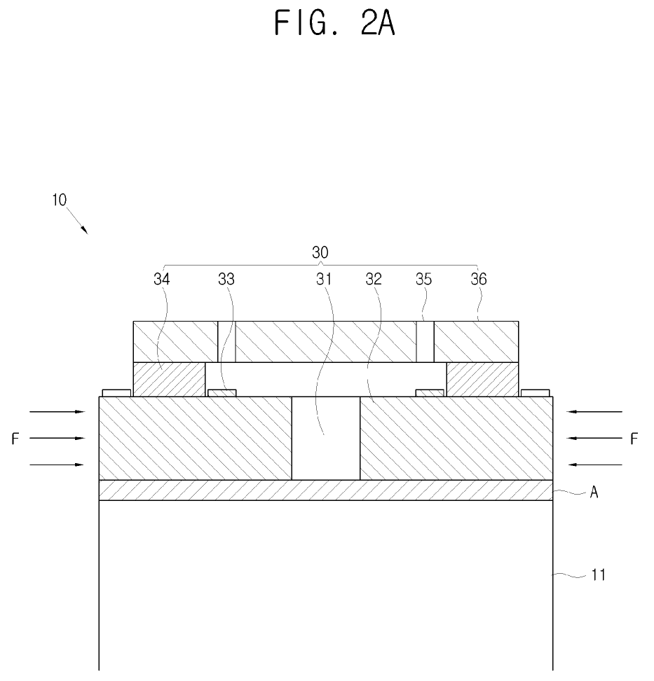

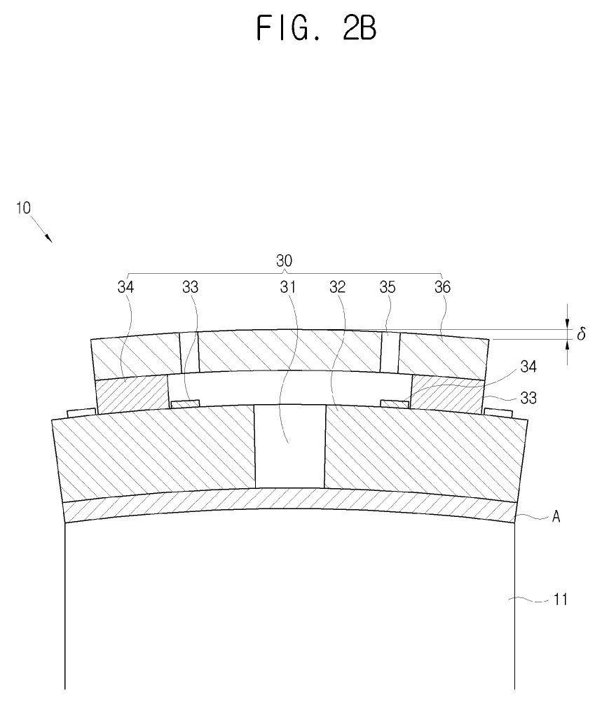

A flexible printed circuit board (similar to FPCB 20 of FIG. 1) can be combined to a lower part of the ink storing part 200 to exchange an electrical signal with an image forming part main body (not illustrated) through a contact pad (similar to contact pad 21 of FIG. 1). The ink storing part 200 may store ink of one color or ink of a plurality of colors. That is, the ink storing part 200 may comprise only a black ink storing part, or may comprise a plurality of ink storing parts 200 to correspond to each color of yellow, magenta, cyan, black and/or other known ink colors, respectively.

The ink storing part 200 may be provided integrally with the head chip 300. Alternatively, the head chip 300 may also be provided on the image forming apparatus main body (not illustrated) and only the ink storing part 200 may be detachably provided.

Since a structure of the ink storing part 200 is similar to that illustrated in FIG. 1, a detailed description thereof is omitted.

As illustrated in FIG. 3A and FIG. 4A, the head chip 300 may comprise a substrate layer 310 having an ink supplying slit 311 having a reinforcing bridge 313, a nozzle layer 330 having a nozzle 333 to discharge an ink droplet onto the recording medium, and a chamber layer 320 having an ink discharging device 321 to supply an energy to discharge the ink through the nozzle 333.

The substrate layer 310 may comprise the ink supplying slit 311 which guides the ink in the ink storing part 200 to the nozzle layer 330, and the reinforcing bridge 313 which is provided in the ink supplying slit 311 to partially block an ink supply and to reinforce a strength of the substrate layer 310. The substrate layer 310 may be provided as a silicon wafer which is generally used in a manufacture of an integrated circuit.

The ink supplying slit 311 is filled with the ink, which is supplied from the ink storing part 200, and supplies the ink to the chamber layer 320. As illustrated in FIG. 3A, the ink supplying slit 311 can be provided to have a predetermined length l. The ink supplying slit 311 may be formed by etching a surface of a substrate 315 which is exposed through the nozzle 333. Alternatively, the ink supplying slit 311 may be formed by etching the surface of the substrate 315 prior to formation of the nozzle layer 330, or may be formed by etching a lower surface of the substrate 315 prior to coupling the substrate to the ink storing part 200.

The ink supplying slit 311 may be provided as a single slit or may be provided plurally as illustrated in FIG. 3A. If the ink supplying slit 311 is provided plurally, each ink supplying slit 311 (311M, 311Y, 311C, and 311K in FIG. 3A) may supply ink of the same color or ink of different color with respect to the other ink supplying slits 311. For example, each ink supplying slit 311Y, 311M, 311C, and 311K may supply yellow, magenta, cyan, and black ink, respectively.

The reinforcing bridge 313 is provided at the ink supplying slit 311 to prevent a bending deformation of the substrate layer 310, which may be generated when the head chip 300 is coupled with the ink storing part 200. As illustrated in FIG. 4A, the reinforcing bridge 313 may partially block the ink supplying slit 311 and reinforces the substrate layer 310 so that the substrate layer 310 may not be deformed by a shear stress F which may be generated by a difference in coefficients of thermal expansion between materials of the substrate 315 and the ink storing part 200. As a length of a part of the ink supplying slit 311 where the bending deformation may occur is decreased due to the reinforcing bridge 313, a maximum bending deformation amount may also be decreased.

For example, a thickness h1 of the reinforcing bridge 313 may be provided not to be greater than a thickness h of the substrate 315. That is, the thickness h1 of the reinforcing bridge 313 may be provided to be smaller than the thickness h of the substrate 315 as illustrated in FIG. 4A or a thickness h2 may be provided same as the thickness h of the substrate 315 as illustrated in FIG. 4B. The ink, which surrounds the reinforcing bridge 313, may be more easily supplied to the chamber layer 320 when the thickness h1 of the reinforcing bridge 313 is provided to be smaller than the thickness h of the substrate 315 than when the thickness h2 of the reinforcing bridge 313 is provided to be the same as the thickness h of the substrate 315.

However, the amount of the deformation which is generated if the ink storing part 200 is combined with the head chip 300 is small when the thickness h2 of the reinforcing bridge 313 is provided to be the same as the thickness h of the substrate 315. Therefore, the thickness of the reinforcing bridge 313 may be provided properly by considering the ink supply to the nozzle 333 and the amount of the deformation of the substrate layer 310.

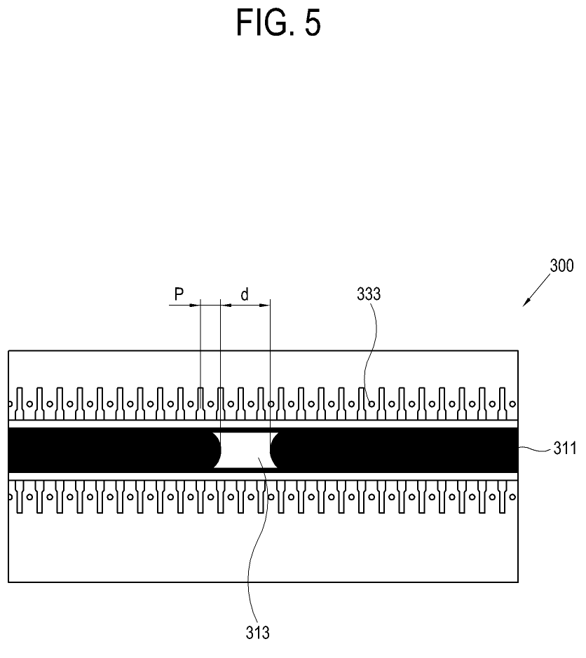

On the other hand, a width d of the reinforcing bridge 313 may be provided not to obstruct the flow of the ink which is supplied to the nozzle 333. Experimentally, as illustrated in FIG. 5, the width d of the reinforcing bridge 313 may be 2 to 6 times as large as a distance p between adjacent nozzles 333. If the width d of the reinforcing bridge 313 is smaller than twice the distance p, the ink may not be smoothly supplied to the nozzle 333 which surrounds the reinforcing bridge 313. Also, if the width d of the reinforcing bridge 313 is larger than six times the distance p, the ink may not be smoothly supplied to the nozzle 333 which is disposed at a center of the plurality of the nozzles 333 surrounding the reinforcing bridge 313.

Also, if a distance between adjacent reinforcing bridges 313 provided at the ink supplying slit 311 is small, deformation of the substrate layer can be reduced. However, the small distance between adjacent reinforcing bridges 313 may be an influence upon the smooth supply of the ink. Therefore, the distance between adjacent reinforcing bridges 313 may be properly provided by considering a width w and the thickness h of the ink supplying slit 311.

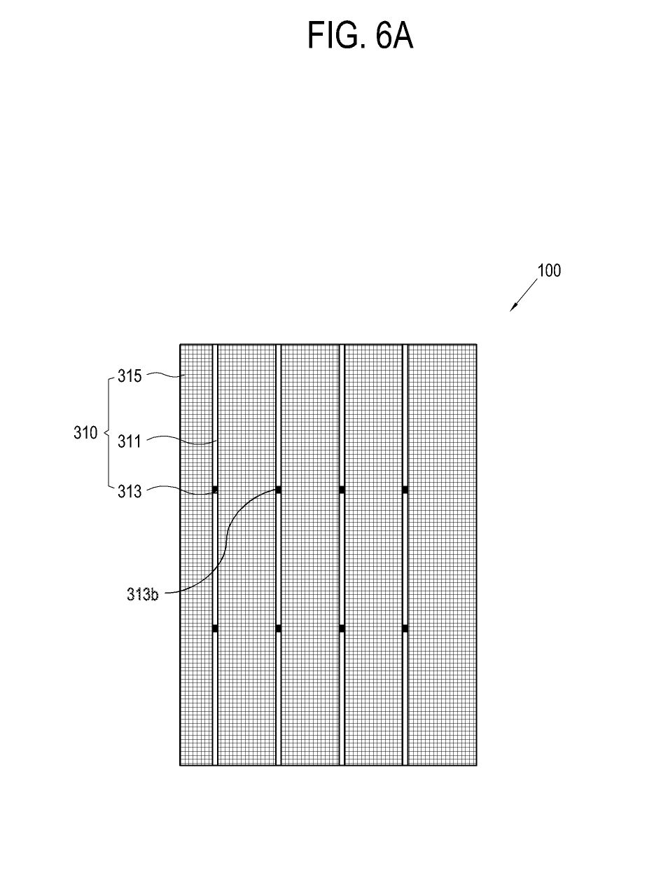

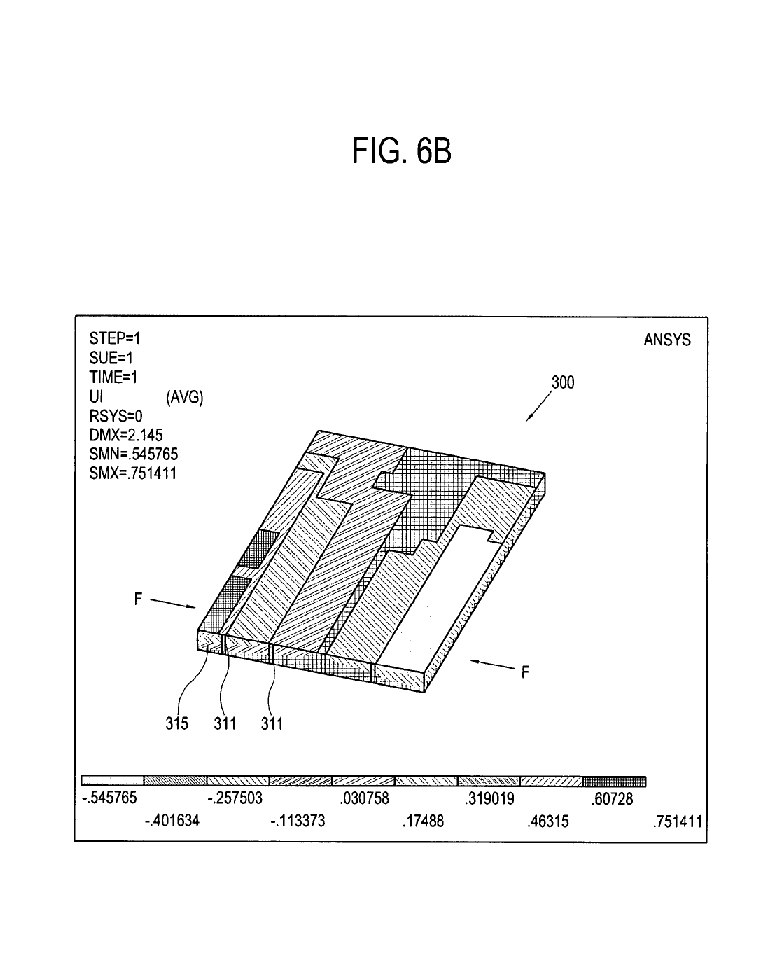

The reinforcing bridge 313 may be provided at each of the plurality of the ink supplying slits 311. In this case, as illustrated in FIG. 3A, the reinforcing bridges 313 may be provided in an alternating pattern so as to not align with a reinforcing bridge of an adjacent ink supplying slit 311. For example, as illustrated in FIG. 3A, reinforcing bridge 313A of ink supplying slit 311Y is provided to alternate with reinforcing bridges 313 of the ink supplying slit 311M. Alternatively, as illustrated in FIG. 6A, the reinforcing bridges 313 may be provided to align with reinforcing bridges 313B which are provided at an adjacent ink supplying slit 311.

The reinforcing bridge 313 may be formed by not etching a part of the substrate 315 to correspond to the thickness h1 and the width d of the reinforcing bridge 313 when the substrate 315 is etched to form the ink supplying slit 311. In this case, the reinforcing bridge 313 is provided integrally with the substrate 315. Alternatively, the reinforcing bridge 313 may be provided by attaching an additional member in the ink supplying slit 311 formed by etching.

The chamber layer 320 may comprise the ink discharging device 321 which supplies the ink with the energy to discharge the ink through the nozzles 333, which is supplied through the ink supplying slit 311, onto the recording medium, and a chamber wall 323 which accommodates the ink discharging device 321. In this case, the ink discharging device 321 may be provided as a piezoelectric device or an electricity-heat transforming device, such as a heater. The chamber wall 323 can be made of epoxy resin. However, the chamber wall 323 may also be made of a photoresist resin of a silicon base, an acryl base, or an imide base.

An electrode 340 can be provided at an outer side of the chamber layer 320 to apply a current to the ink discharging device 321. The electrode 340 may be made of aluminum or aluminum alloy which has a superior conductivity and may be easily patterned. Additionally, the electrode 340 can be provided as a layer formed over the ink discharging device 321 to supply a current thereto.

The nozzle layer 330 may comprise the plurality of the nozzles 333 to discharge ink by the energy supplied by the ink discharging device 321 of the chamber layer 320. In this case, the more nozzles 333 that are provided, the more a printing quality is improved. Therefore, the nozzles 333 may be provided to be disposed in their maximum number per unit area.

Hereinafter, an operating process of the ink cartridge 100 according to the present general inventive concept is described. First, the ink which is supplied from the ink storing part 200 flows through the ink supplying slit 311 of the substrate layer 310 and into the chamber layer 320. The ink which fills the chamber layer 320 is discharged to the outside through the nozzle 333 by the energy supplied by the ink discharging device. For example, by an abrupt heating or vibration of the ink discharging device 321. That is, if the ink discharging device 321 is heated, an ink bubble is generated in the ink in the chamber layer 320. Then, the generated bubble pushes the ink via an expanding force of the bubble, so that the ink can be discharged through the nozzle 333.

FIG. 6B illustrates an experimental result of an analysis through ANSYS on the deformation amount of the substrate layer 310 when the shear stress F of 20 [MPa] is applied to the head chip 300 of the ink cartridge 100 according to the present general inventive concept.

According to the experimental result, when there is no reinforcing bridges, the maximum deformation amount of the ink supplying slit 311 of the substrate layer 310 was 6.57 [μm]. On the other hand, as illustrated in FIG. 6A, in the head chip 300 according to the present general inventive concept having five reinforcing bridges 313 each with a respective width of 84 [μm] for each ink supplying slit 311, the maximum deformation amount due to the same shear stress F was estimated to be 0.276 [μm]. Therefore, it can be seen that a hardness of the head chip 300 according to the present general inventive concept is increased by about 24 times as much as that of the head chip lacking reinforcing bridges.

As described above, as the head chip according to embodiments of the present general inventive concept and the ink cartridge having the head chip comprise the plurality of the reinforcing bridges in the ink supplying slit, the bending deformation, which is generated when the ink storing part is combined with the head chip, can be minimized.

Also, as described above, the bending deformation of the head chip can be minimized by the reinforcing bridge, so that an ink discharging direction can be uniformly maintained, thus enhancing the printing quality.

Also, as a degree of the bending deformation is small, a surface of the nozzle can be maintained undamaged during a wiping process.

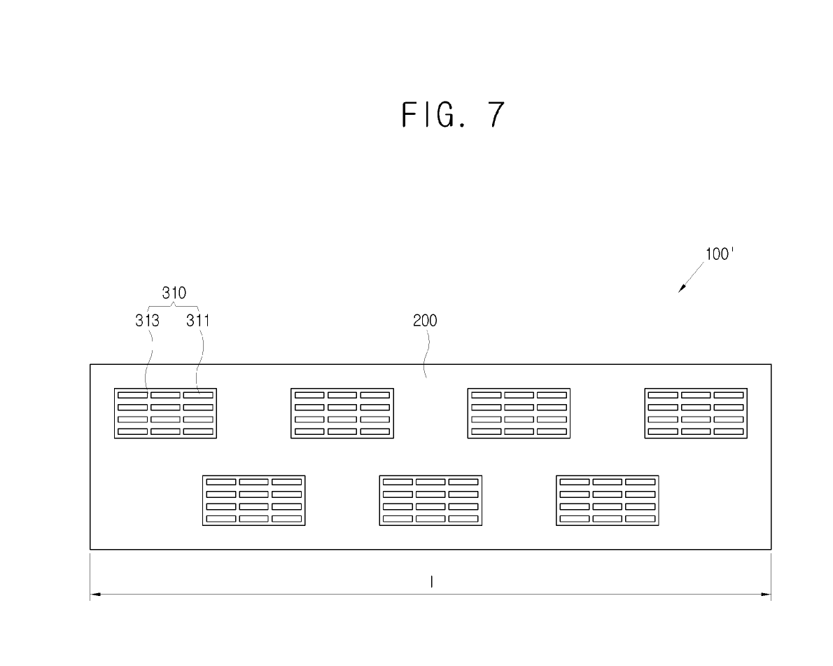

In the above description, the ink cartridge according to the exemplary embodiment of the present general inventive concept is a shuttle type ink cartridge which comprises only one head chip. However, the present general inventive concept is not limited thereto, and as illustrated in FIG. 7, the ink cartridge according to the present general inventive concept is applicable to a line head type ink cartridge with a width that corresponds to a width of the printing medium and comprising a plurality of the head chips.

As described above, according to the present general inventive concept, the head chip and the ink cartridge, where the bending deformation of the substrate layer can be minimized, may be provided by having the reinforcing bridge in the ink supplying slit to reinforce the strength of the substrate layer.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A head chip usable in an image forming apparatus, the head chip comprising:
a nozzle layer having a nozzle to discharge ink onto a recording medium;
a substrate layer having at least one ink supplying slit provided to be parallel with the nozzle layer to supply the nozzle with the ink; and
at least one reinforcing bridge provided along an extending direction of the ink supplying slit and blocks at least one region of the ink supplying slit.

2. The head chip of claim 1, wherein a thickness of the reinforcing bridge is not greater than the thickness of the substrate layer.

3. The head chip of claim 2, wherein a width d of the reinforcing bridge is p×2≦d≦p×6 and p is a pitch between adjacent nozzles.

4. The head chip of claim 1, wherein a width d of the reinforcing bridge is p×2≦d≦p×6 and p is a pitch between adjacent nozzles.

5. The head chip of claim 1, wherein the reinforcing bridge is provided plurally along the extending direction of the ink supplying slit.

6. The head chip of claim 1, wherein the substrate layer comprises a plurality of ink supplying slits which are provided to be parallel therewith.

7. The head chip of claim 6, wherein each of the plurality of ink supplying slits supplies the nozzle with ink of a different color.

8. The head chip of claim 6, wherein a reinforcing bridge of a first ink supplying slit is aligned with a reinforcing bridge of a neighboring ink supplying slit.

9. The head chip of claim 6, wherein a reinforcing bridge of a first ink supplying slit does not align with a reinforcing bridge of an adjacent ink supplying slit.

10. An ink cartridge usable in an image forming apparatus, the ink cartridge comprising:
an ink storing part; and
a head chip disposed at a lower side of the ink storing part to discharge ink onto a recording medium, the head chip comprising:
a nozzle layer having a nozzle to discharge ink onto a recording medium;
a substrate layer having at least one ink supplying slit provided to be parallel with the nozzle layer and supplies the nozzle with the ink; and
at least one reinforcing bridge provided along an extending direction of the ink supplying slit and blocks at least one region of the ink supplying slit.

11. The ink cartridge of claim 10, wherein the ink storing part is provided to correspond to a width of a printing medium and comprises a plurality of head chips.

12. The ink cartridge of claim 10, wherein a thickness of the reinforcing bridge is not greater than the thickness of the substrate layer.

13. The ink cartridge of claim 10, wherein a width d of the reinforcing bridge is p×2≦d≦p×6 and p is a pitch between adjacent nozzles.

14. The ink cartridge of claim 12, wherein a width d of the reinforcing bridge is p×2≦d≦p×6 and p is a pitch between adjacent nozzles.

15. The ink cartridge of claim 10, wherein the reinforcing bridge is provided plurally along the extending direction of the ink supplying slit.

16. The ink cartridge of claim 10, wherein the substrate layer comprises a plurality of ink supplying slits which are provided to be parallel therewith.

17. The ink cartridge of claim 10, wherein each of the plurality of ink supplying slits supplies the nozzle with ink of a different color.

18. The ink cartridge of claim 10, wherein a reinforcing bridge of a first ink supplying slit is aligned with a reinforcing bridge of a neighboring ink supplying slit.

19. The ink cartridge of claim 10, wherein the reinforcing bridge of a first ink supplying slit does not align with a reinforcing bridge of an adjacent ink supplying slit.
